(19) United States
(12) Patent Application Publication
(10) Pub. No.: US 2019/0131751 A1
(43) Pub. Date: May 2, 2019

(54) INSTALLATION SYSTEM FOR A CEILING FAN

(71) Applicant: TTI (MACAO COMMERCIAL OFFSHORE) LIMITED, Macau (MO)

(72) Inventors: Ronald C. McCurry, West Union, SC (US); Anthony T. Tocco, Easley, SC (US)

(21) Appl. No.: 16/175,404

(22) Filed: Oct. 30, 2018

Related U.S. Application Data
(60) Provisional application No. 62/579,658, filed on Oct. 31, 2017.

(51) Int. Cl. H01R 33/46; H02K 5/22; H02K 7/14; H01R 35/04; H01R 33/97; F04D 25/08; F04D 29/64

(52) U.S. Cl. CPC H01R 33/46; H02K 5/225; H02K 7/14; H01R 4/22; H01R 33/973; F04D 25/088; F04D 29/646; H01R 35/04

(57) ABSTRACT

A ceiling fan includes a fan assembly having a motor housing, a motor positioned within the motor housing and including a drive shaft that defines an axis of rotation, a fan operable to be rotated by the motor, and a first electrical terminal electrically coupled to the motor. The ceiling fan also includes a downrod having a first end adjacent a ceiling and a second end opposite the first end and an installation system coupled to the second end of the downrod. The installation system includes a mounting bracket and an electrical connector coupled to the mounting bracket. The electrical connector includes a rotating terminal with a second electrical terminal that couples to the first electrical terminal to couple the fan assembly to the installation system.

### CROSS REFERENCE TO RELATED APPLICATIONS

This application claims priority to U.S. Provisional Patent Application No. 62/579,658, filed Oct. 31, 2017, the entire contents of which are incorporated herein by reference.

### BACKGROUND

The present invention relates to an installation system for a ceiling fan and, in particular, a quick-connect installation system that connects both the mechanical and electrical components.

Typically, to install a ceiling fan, the ceiling fan must be held by a user while the electrical components are connected. Some ceiling fans are large and heavy and may be hard to hold while the electrical components are connected. In addition, some fans may have a wide diameter that makes it hard to reach the center of the unit where the electrical components are located.

### SUMMARY

In one embodiment, the invention provides a ceiling fan including a fan assembly having a motor housing with first and second mounting pins and a motor positioned within the motor housing. The motor includes a drive shaft that defines an axis of rotation. The fan assembly also includes a fan operable to be rotated by the motor and a first electrical terminal electrically coupled to the motor. The ceiling fan also includes an installation system having a mounting bracket with a central portion, a first flange extending downwardly from the central portion, and a second flange extending downwardly from the central portion. The first flange includes a first track and the second flange includes a second track. The installation system also includes an electrical connector. The electrical connector is coupled to the mounting bracket. The electrical connector includes a rotating terminal with a second electrical terminal. The fan assembly is adapted to be coupled to the installation system by moving the first and second mounting pins within the first and second tracks in a first direction parallel to the axis of rotation to couple the first electrical terminal to the second electrical terminal and then rotating the fan assembly relative to the installation system about the axis of rotation to secure the fan assembly to the installation system.

In another embodiment, the invention provides a ceiling fan including an installation system having a mounting bracket and an electrical connector coupled to the mounting bracket. The electrical connector includes a rotating terminal with a first electrical terminal. The ceiling fan also includes a fan assembly that is coupled to the installation system. The fan assembly includes a motor housing, a motor positioned within the motor housing and including a drive shaft that defines an axis of rotation, a fan operable to be rotated by the motor, and a second electrical terminal electrically coupled to the motor. The fan assembly is adapted to be coupled to the installation system by moving the fan assembly axially along the axis of rotation to couple the first electrical terminal to the second electrical terminal, then by rotating the fan assembly about the axis of rotation to secure the fan assembly to the installation system. The installation assembly is configured to couple to the fan assembly at a first position adjacent a ceiling and is configured to couple to the fan assembly at a second position at a lower end of a downrod.

In another embodiment, the invention provides a ceiling fan including a fan assembly having a motor housing, a motor positioned within the motor housing and including a drive shaft that defines an axis of rotation, a fan operable to be rotated by the motor, and a first electrical terminal electrically coupled to the motor. The ceiling fan also includes a downrod having a first end adjacent a ceiling and a second end opposite the first end and an installation system coupled to the second end of the downrod. The installation system includes a mounting bracket and an electrical connector coupled to the mounting bracket. The electrical connector includes a rotating terminal with a second electrical terminal that couples to the first electrical terminal to couple the fan assembly to the installation system.

In another embodiment, the invention provides a ceiling fan including a fan assembly having a motor housing with first and second mounting pins, a motor positioned within the motor housing with a drive shaft that defines an axis of rotation, a fan operable to be rotated by the motor, and a first electrical terminal electrically coupled to the motor. The ceiling fan also includes an installation system having a mounting bracket with a first track and a second track on a diametrically opposite side of the mounting bracket from the first track and an electrical connector coupled to the mounting bracket. The electrical connector includes a rotating terminal with a second electrical terminal configured to couple to the first electrical terminal to supply power to the motor. The installation system also includes a latch mechanism positioned at one end of the first track, the latching mechanism is moveable between a first closed position in which the first mounting pin is secured within the first track to couple the fan assembly to the installation system and a second open position in which the fan assembly is able to rotate relative to the installation system within the first track.

Other aspects of the invention will become apparent by consideration of the detailed description and accompanying drawings.

### BRIEF DESCRIPTION OF THE DRAWINGS

FIG. 1 is s perspective view of a ceiling fan.

FIG. 2 is a perspective view of a fan assembly of the ceiling fan of FIG. 1.

FIG. 3 is a perspective view of an installation system of the ceiling fan of FIG. 1.

FIG. 4 is a perspective view of an electrical box of the installation system of FIG. 3.

FIG. 5 is a perspective view of a mounting bracket of the installation system of FIG. 3.

FIG. 6 is an exploded view of an electrical connector of the installation system of FIG. 3.

FIG. 7 is a second perspective view of the installation system of FIG. 3.

FIG. 8 is a perspective view of the ceiling fan of FIG. 1 being installed.

FIG. 9 is a second perspective view of the ceiling fan of FIG. 1 being installed.

FIG. 10 is perspective view of the ceiling fan of FIG. 1 installed.

FIG. 11 is a perspective view of a release mechanism of the ceiling fan of FIG. 1

FIG. 12 is an elevational view of another ceiling fan.

FIG. 13 is an elevational view of an installation system of the ceiling fan of FIG. 12

FIG. 14 is a perspective view of a downrod of the installation system of FIG. 13.

FIG. 15 is a perspective view of a downrod adapter for the installation system of FIG. 13.

FIG. 16 is a perspective view of a downrod mounting bracket of the installation system of FIG. 13.

FIG. 17 is a partial perspective view of the installation system of FIG. 13.

FIG. 18 is a partial perspective view of the installation system of FIG. 13 being installed.

FIG. 19 is an elevational view of the installation system of FIG. 13 being installed.

FIG. 20 is a perspective view of the installation system of FIG. 13 being installed.

FIG. 21 is another partial perspective view of the installation system of FIG. 13 being installed.

FIG. 22 is another partial perspective view of the installation system of FIG. 13 being installed.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

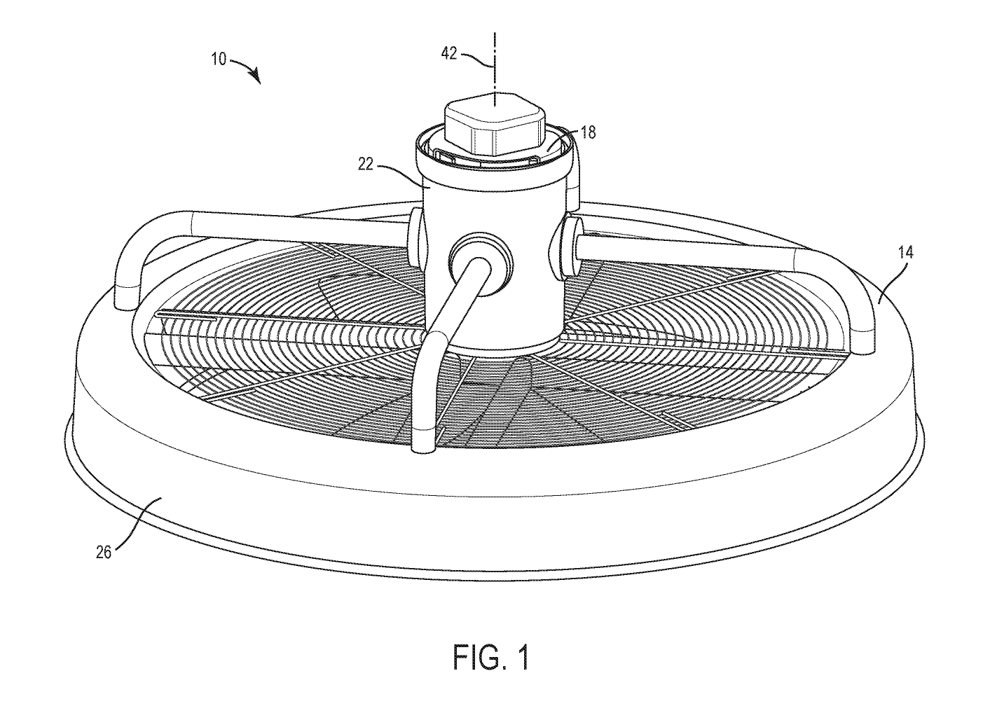

FIG. 1 illustrates a ceiling fan 10 including a fan assembly 14 and an installation system 18. The ceiling fan 10 is configured to mount to a ceiling or other structure to assist in circulating air within a room or area where the ceiling fan 10 is positioned. In the illustrated embodiment, the ceiling fan 10 has a large diameter and is intended to circulate air within large rooms. In other embodiments, the ceiling fan 10 can have any sized diameter to circulate air within any sized room or area.

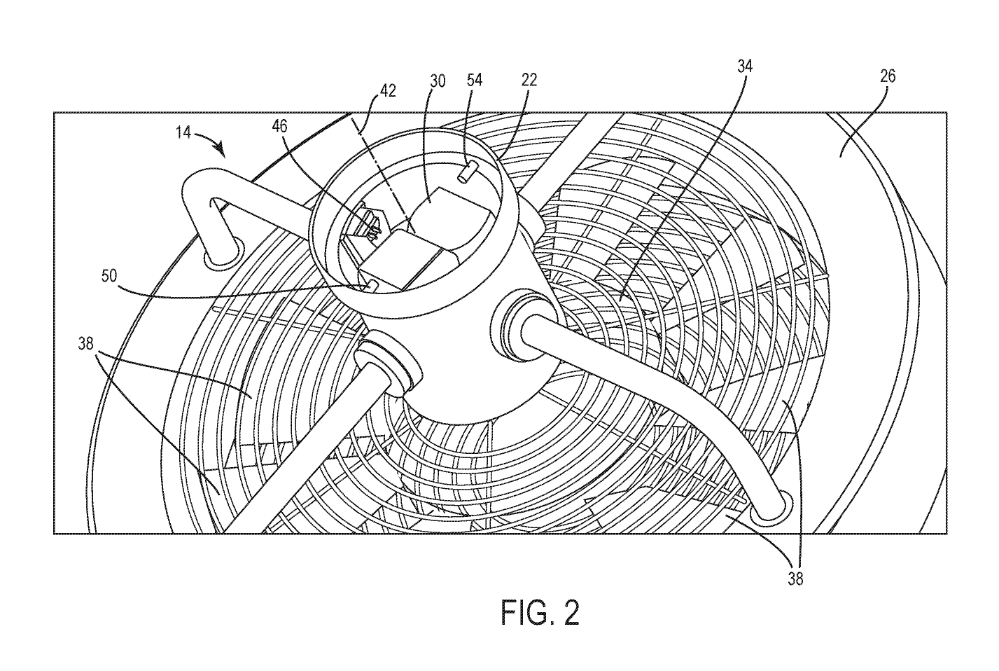

With reference to FIG. 2, the fan assembly 14 includes a motor housing 22, a fan housing 26, a motor 30, and a fan 34. The fan 34 is positioned within the fan housing 26 and includes blades 38. The motor 30 is positioned within the motor housing 22 and includes a drive shaft (not shown) that is coupled to the fan 34. The drive shaft defines an axis of rotation 42 for the fan assembly 14. The motor 30 is operable to rotate the fan 34, and thereby the fan blades 38, and receives A/C power from an external power source. In the illustrated embodiment, the fan assembly 14 is prewired. In other words, a user does not need to assemble any electrical components for the fan assembly 14 prior to installation. A male electrical terminal 46 is positioned on the inside of the motor housing 22 and is electrically coupled to the motor 30. Further, the motor housing 22 includes a first mounting pin 50 and a second mounting pin 54 positioned opposite the first mounting pin 50 on the inside of the motor housing 22. In the illustrated embodiment, the first mounting pin 50 has a larger diameter than the second mounting pin 54. In other embodiments, the first mounting pin 50 may be the same size as the second mounting pin 54. In further embodiments, the motor housing may include additional mounting pins.

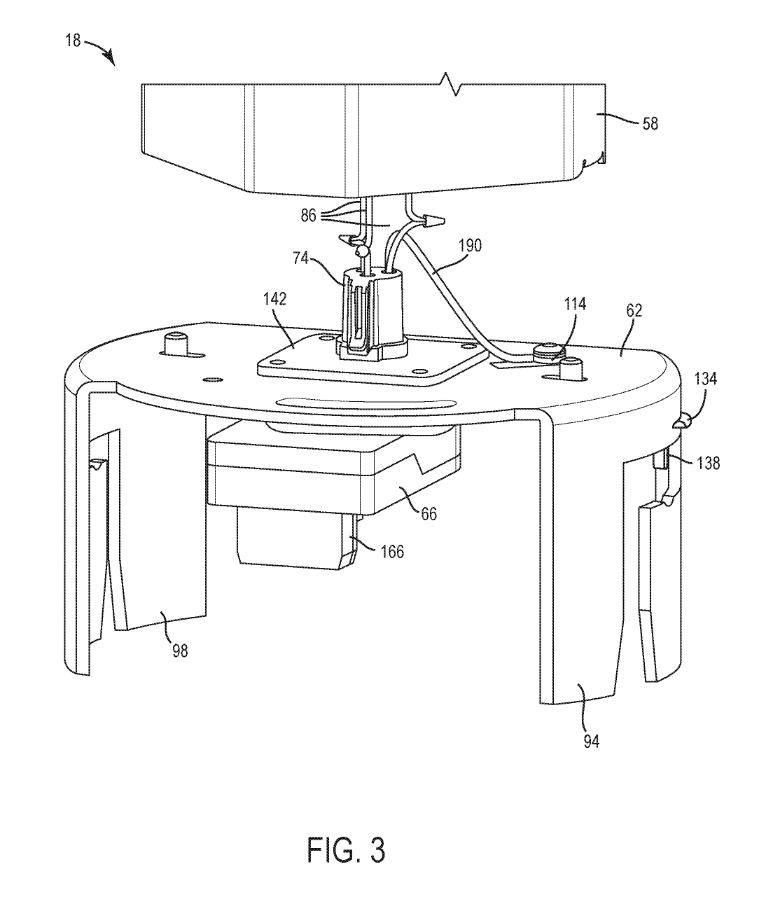

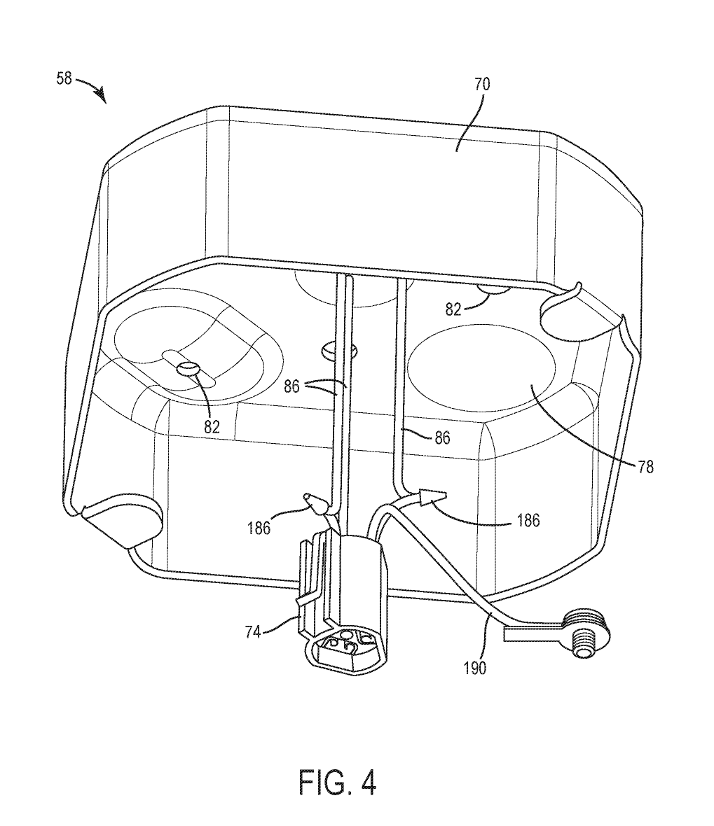

FIGS. 3-6 illustrate the installation system or quick connection mechanism 18 attached to an electrical box 58. The installation system 18 includes a mounting bracket 62 and an electrical connector 66. With references to FIG. 4, the electrical box 58 includes a housing 70 and a plug connector 74. On a top surface 78 of the electrical box are a first set of apertures 82 that are used to secure the electrical box 58 to a ceiling or other support structures and a second set of apertures (not shown) that existing home wires 86 are threaded through and coupled to the plug connector 74. The electrical box 58 can be any known electrical box for mounting a fan and light fixtures, whether to or in a ceiling.

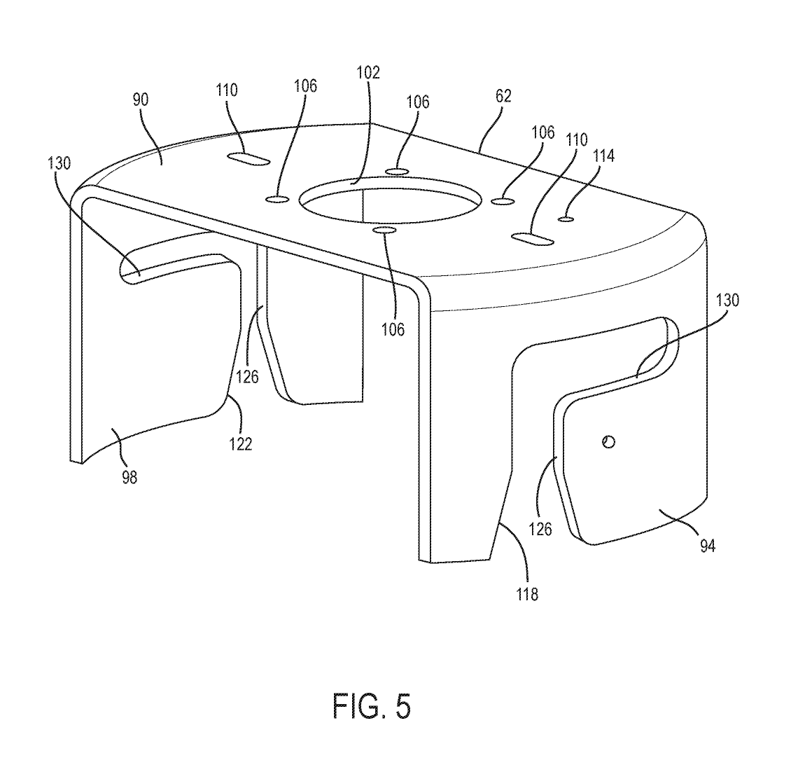

With reference to FIG. 5, the mounting bracket 62 includes a central portion 90 with a first flange 94 and a second flange 98 extending downwardly from the central portion 90. The number of flanges can depend on the number of mounting pins; therefore, fewer of more flanges can be used. The central portion 90 includes a central aperture 102, a set of circular apertures 106, a set of elongated apertures 110, and a lone aperture 114. The first flange 94 includes a first track 118 and the second flange 98 includes a second track 122. In the illustrated embodiment, each track 118, 122 is generally L-shaped and includes a first portion 126 and a second portion 130. The first portions 126 of both tracks 118, 122 are substantially parallel to the axis of rotation 42 and the second portions 130 are substantially perpendicular to the axis of rotation 42. The second portions 130 extend from the first portions 126 in a counterclockwise direction. In other embodiments, the second portions 130 may extend from the first portions 126 in a clockwise direction. In the illustrated embodiment, the first track 118 on the first flange 94 is wider than the second track 122 on the second flange 98. In other embodiments, the first track 118 and the second track 122 may be the same width. The widths of the first and second tracks 118, 122 correspond to the diameter of the first and second mounting pins 50, 54 respectively. The mounting bracket 62 further includes a latch mechanism 134 (FIG. 3) positioned at the end of the second portion 130 of the first track 118. The latching mechanism 134 includes a pivotable hook 138 that is spring biased to a closed position in which the latching mechanism 134 prevents passage through the first track 118. The hook 138 may be forced against its bias to an open position by, for example, the first mounting pin 50 sliding along the first track 118.

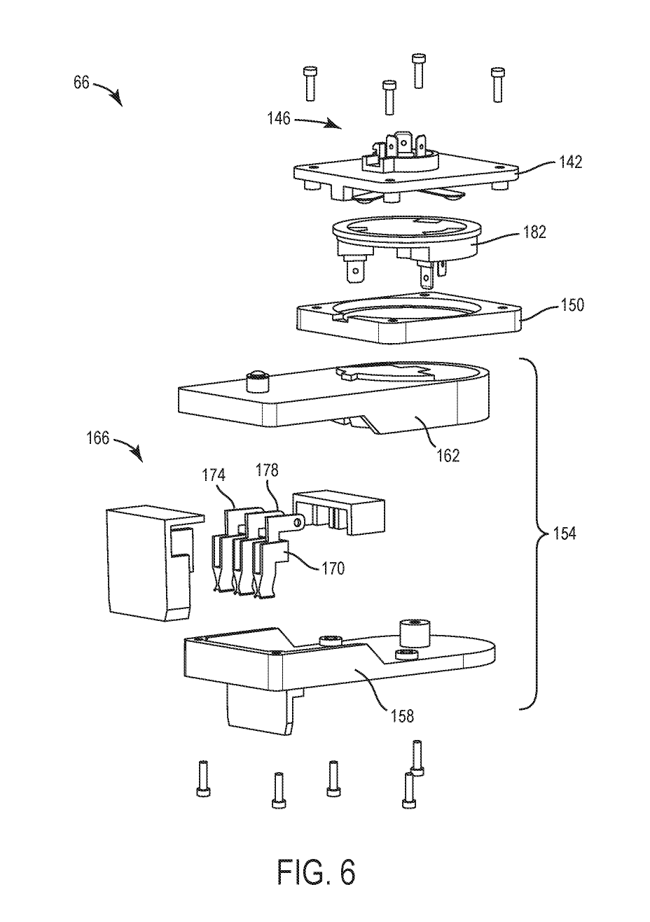

With reference to FIG. 6, the electrical connector 66 includes an upper bracket 142 with electrical terminals 146, a lower bracket 150, and an electrical housing 154. The electrical connector 66 is positioned within the central aperture 102 of the mounting bracket 62 and the upper bracket 142 is secured to the mounting bracket 62 with fasteners through the set of apertures 106. The electrical housing 154 includes a lower housing 158 and an upper housing 162. Positioned between the lower housing 158 and the upper housing 162 is a female electrical terminal 166 including ground 170, positive 174, and neutral terminals 178 that correspond to terminals on the male electrical terminal 46. The electrical housing 154 is secured to the lower bracket 150 with fasteners. In the illustrated embodiment, the lower bracket 150 is rotatable relative to the upper bracket 142 with a rotating terminal 182. The rotating terminal 182 is electrically coupled to the terminals 146 on the upper bracket 142 and to the terminals 170, 174, 178, on the electrical terminal 166. The rotating terminal 182 maintains an electrical connection between the terminals 146 on the upper bracket 142 and the electrical terminal 166 even when rotated. In the illustrated embodiment, the rotating terminal 182 rotates thirty degrees around the axis of rotation 42. In some embodiments, the rotating terminal rotates ninety degrees around the axis of rotation. In other embodiments, the rotating terminal 182 rotates endlessly around the axis of rotation 42.

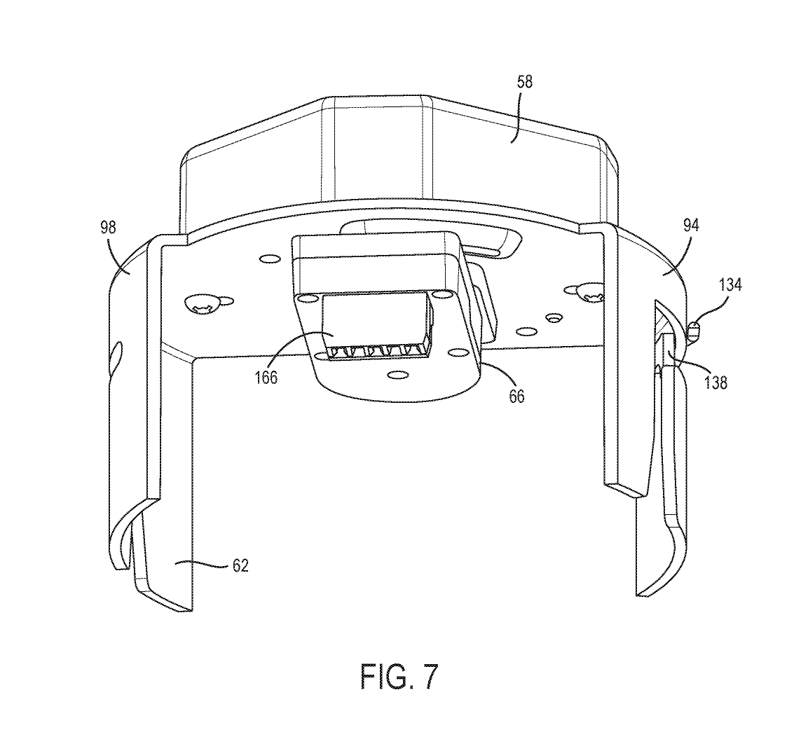

As discussed above, during installation of the ceiling fan 10, the electrical box 58 is coupled to the ceiling and the existing home wires 86 are electrical coupled to the plug connector 74 using wire nuts 186. As shown in FIG. 3, the plug connector 74 is then coupled to the terminals 146 on the upper bracket 142 of the electrical connector 66 and a ground wire 190 from the plug connector 74 is secured to the mounting bracket 62 with a fastener through the aperture 114. With reference to FIG. 7, the mounting bracket 62 is then coupled to the electrical box 58 with fasteners through the set of apertures 110. The installation system 18 is now electrically wired and ready to receive the fan assembly 14.

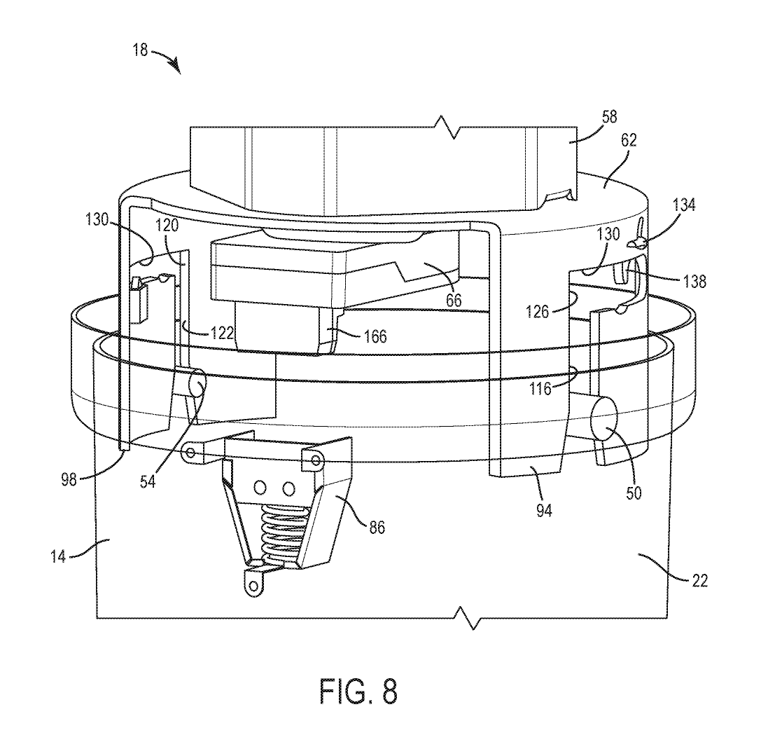

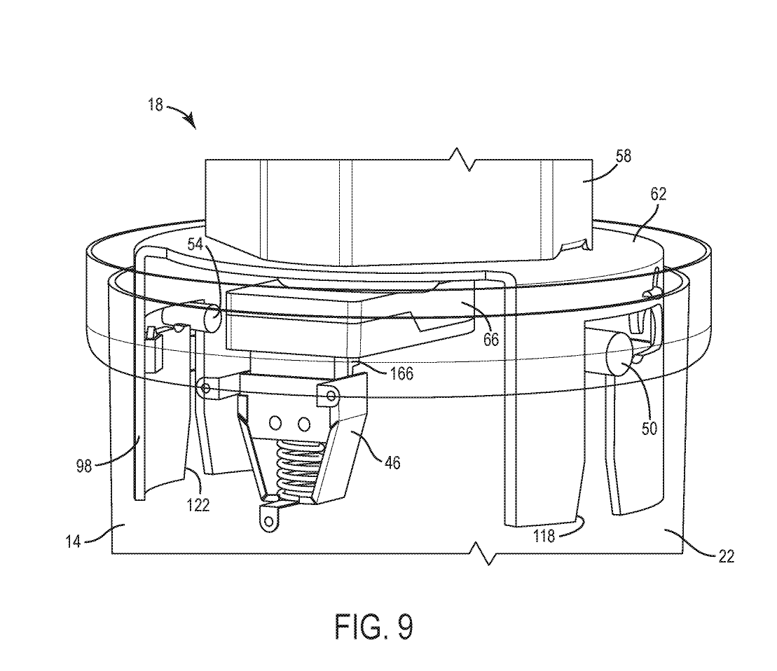

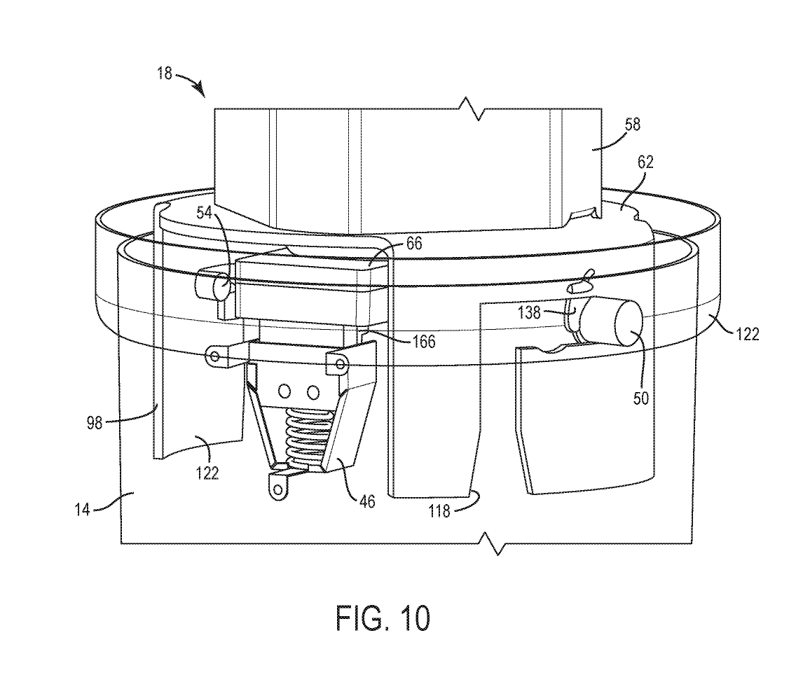

FIGS. 8-10 illustrate the fan assembly 14 being installed on the installation system 18. The entire fan assembly 14 is first lifted into place by positioning the first mounting pin 50 within the first track 118 and the second mounting pin 54 within the second track 122. The mounting pins 50, 54 are then slid along the first portions 126 of the first and second tracks 118, 122. When the mounting pins 50, 54 come to the end of the first portions 126 of the tracks 118, 122, the female electrical terminal 166 and the male electrical terminal 46 are automatically engaged and all the electrical connections of the ceiling fan 10 are complete. In other embodiments, the female electrical terminal 166 and the male electrical terminal 46 could be switched so that the male electrical terminal 46 is on the installation system 18 and the female electrical terminal 166 is on the motor housing 22.

The mounting pins 50, 54 of the fan assembly 14 can now be rotated counterclockwise along the second portions 130 of the tracks 118, 122. As the fan assembly 14 is rotated, the male and female terminals 46, 166 will rotate along, keeping the electrical connection between them, through the rotating terminal 182. In other words, the mounting bracket 62 remains fixed while the rotating terminal 182 rotates with the fan assembly 14. When the fan assembly 14 approaches the end of the second portions 130 of the tracks 118, 122, the first mounting pin 50 engages the latch mechanism 134. The first mounting pin 50 biases the latch mechanism 134 open until the first mounting pin 50 has passed the latch mechanism 134. The latch mechanism 134 then returns to the closed position, securing the fan assembly 14 to the installation system 18. In further embodiments, the ceiling fan 10 may include additional means of securing the fan assembly 14 to the installation system 18.

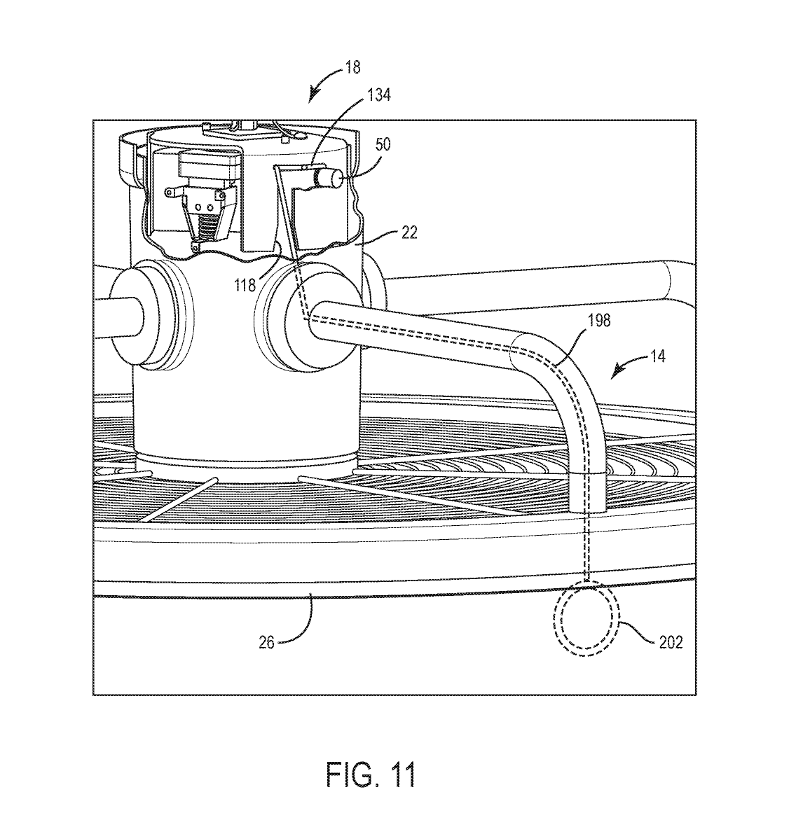

In the illustrated embodiment, the ceiling fan 10 includes a release mechanism. As shown in FIG. 11, the release mechanism includes a cable 198 that at one end is coupled to the latch mechanism 134 and at the other to a release ring 202. The cable 198 is positioned through part of the fan housing 26 to a location where a user can easily access the release ring 202. The release ring 202, when pulled, biases the latch mechanism 134 to the open position releasing the first mounting pin 50 and allowing the fan assembly 14 to rotate within the tracks 118, 122. As such, the fan assembly 14 can quickly and easily be installed or uninstalled from the installation system 18.

Providing a ceiling fan 10 with an installation system 18 and a fan assembly 14 with a quick connect mechanism 62 advantageously provides for quick and easy installation of a ceiling fan 10. In addition, the fan assembly 14 can be easily replaced for a new or different one.

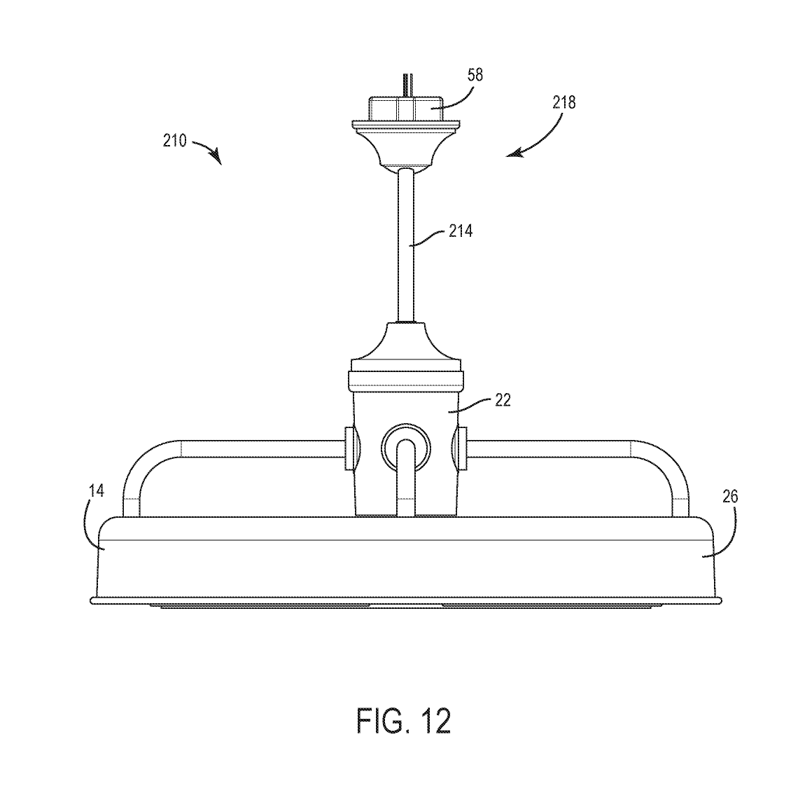

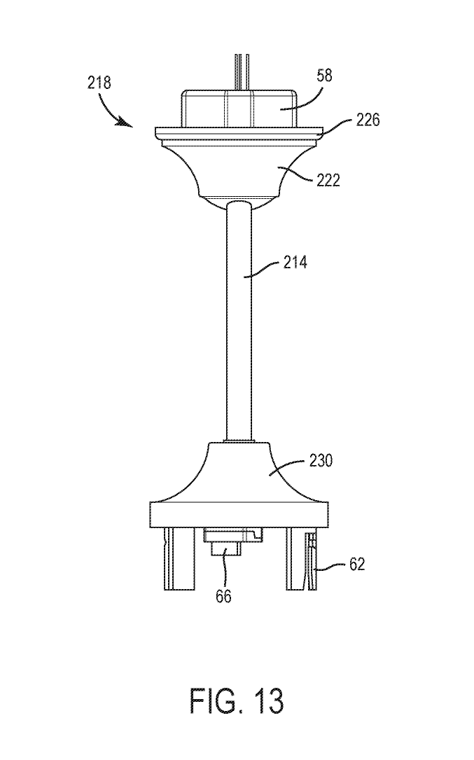

FIG. 12 illustrate a ceiling fan 210 according to another embodiment of the invention, with like features being shown with like reference numerals. The ceiling fan 210 is similar to the ceiling fan 10 but includes a downrod 214 between the electrical box 58 and the mounting bracket 62. The ceiling fan 210 includes the fan assembly 14, an installation system or quick connect mechanism 218, a downrod 214, a canopy 222, a screw cover 226, and a lower bezel 230. As shown in FIG. 13, the installation system 218 includes the mounting bracket 62 and the electrical connector 66.

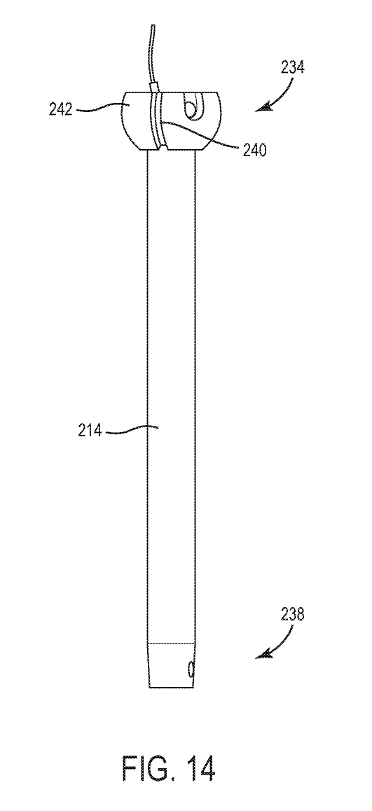

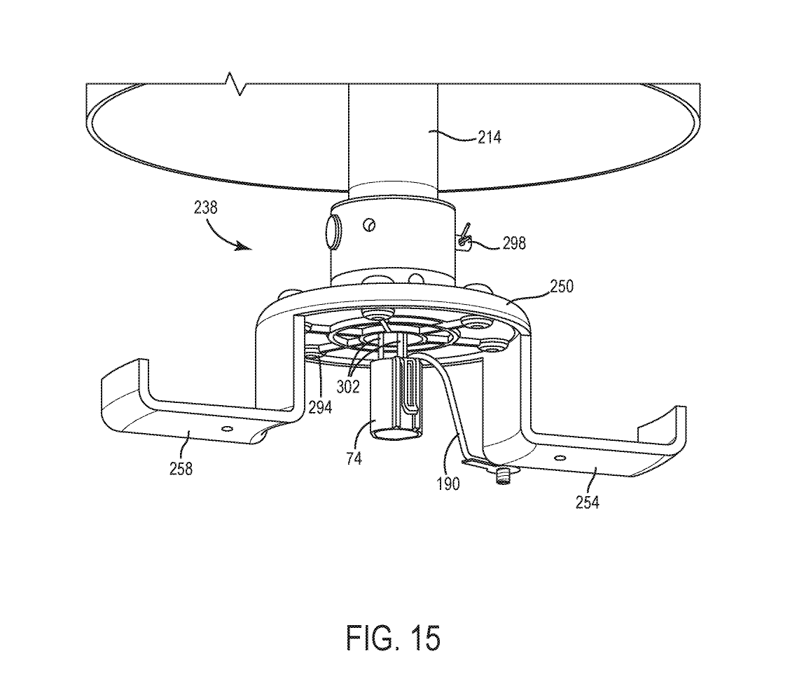

With reference to FIGS. 14 and 15, the downrod 214 is generally cylindrically and includes a first end 234 and a second end 238 opposite the first end 234 that extends generally parallel to the axis of rotation 42. In the illustrated embodiment, the downrod 214 may be a variable length within a range from 12 inches to 72 inches. A hangar ball 242 with a vertical groove 246 is coupled to the first end 234 of the downrod 214 with a fastener, and an adaptor bracket 250 is coupled to the second end 238 of the downrod 214 with fasteners. The adaptor bracket 250 includes a first flange 254 and a second flange 258 opposite the first flange 254. The first and second flanges 254, 258 are generally U-shaped.

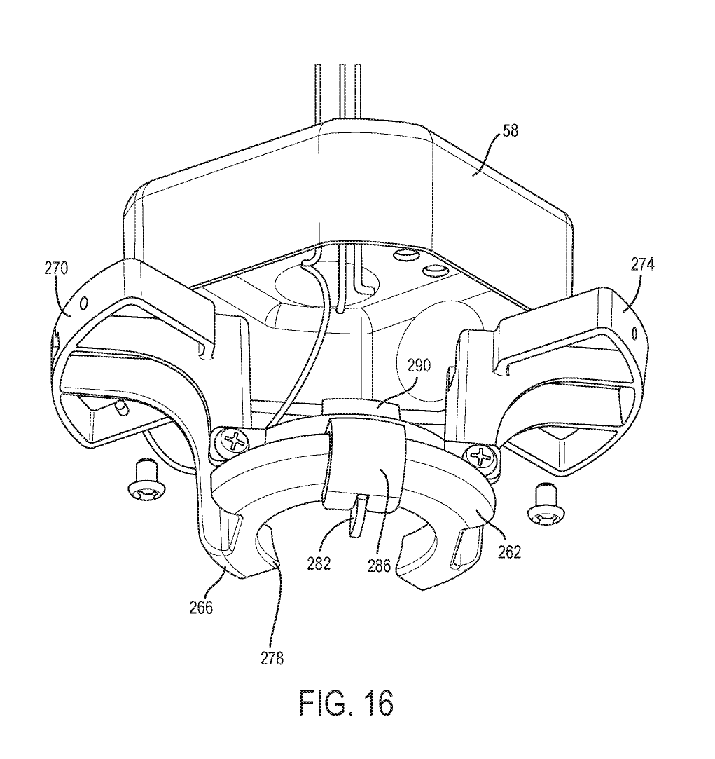

With reference to FIG. 16, a downrod mounting bracket 262 is coupled to the electrical box 58. The downrod mounting bracket 262 includes a center portion 266, a first flange 270, and a second flange 274. The first and second flanges 270, 274 are secured to the electrical box 58 with fasteners. The center portion 266 includes a seat 278 with a tab 282 that corresponds to the groove 246 of the hangar ball 242. In addition, the downrod mounting bracket 262 includes a retainer bracket 286 with a lip 290 that is configured to keep the downrod 214 in place during installation.

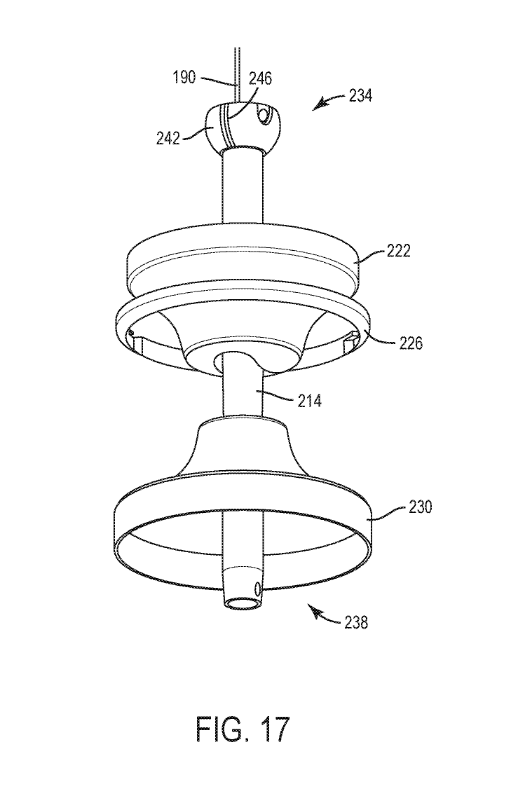

FIGS. 17-24 illustrate installation of the ceiling fan 210. The canopy 222, canopy screw cover 226, and lower bezel 230 are first slid over the second end 238 of the downrod 214 respectively (FIG. 17). Then, a motor bracket 294 (FIG. 15) is secured to the second end 238 of the downrod 214 with a clevis/cotter pin combination 298 and a ground wire 190 is secured to the first end 234 of the downrod 214 with a screw. The adaptor bracket 250 is then coupled to the motor bracket 294 with fasteners. Next, lead wires 302 are coupled to the plug connector 74 and fed through the length of the downrod 214. In the illustrated embodiment, the lead wires 302 are long enough to extend fully through the downrod 214 with an additional four inches extending from the first end 234. In other embodiments, the lead wires 302 may extend further from the first end 234 of the downrod 214.

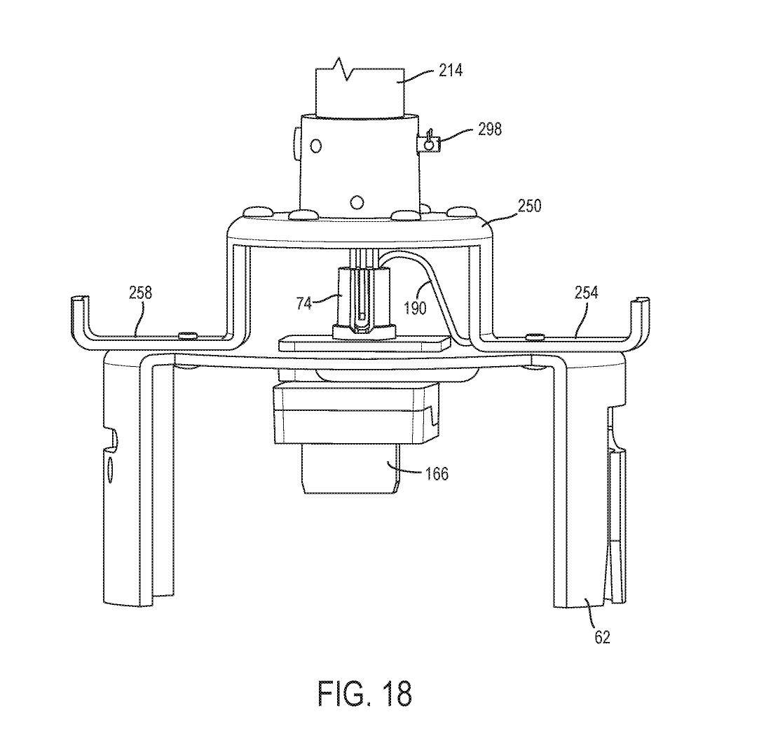

The quick connect mechanism 218 is then mounted to the adaptor bracket 250 coupled to the downrod 214. In particular, the mounting bracket 62 is coupled to the downrod adaptor bracket 250 and a ground wire 190 from the plug connector 74 is secured to the mounting bracket 62 (FIG. 18).

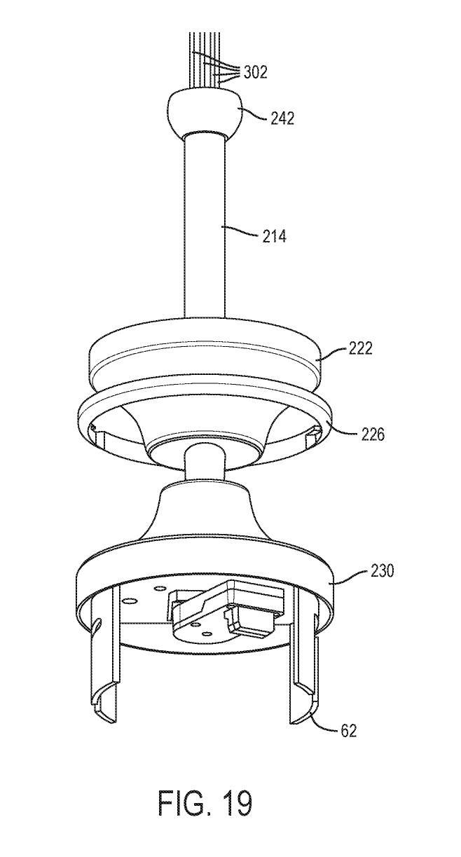

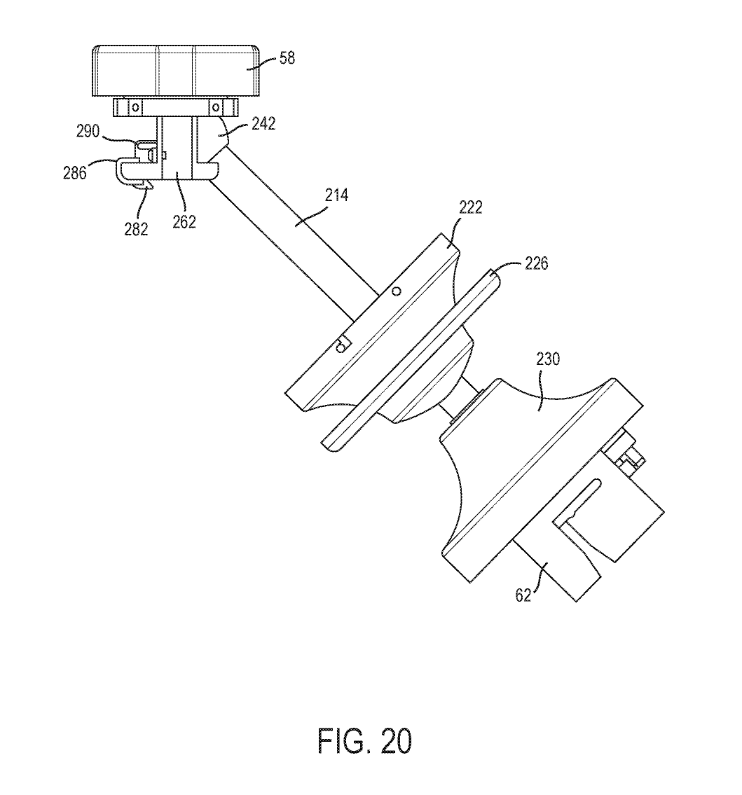

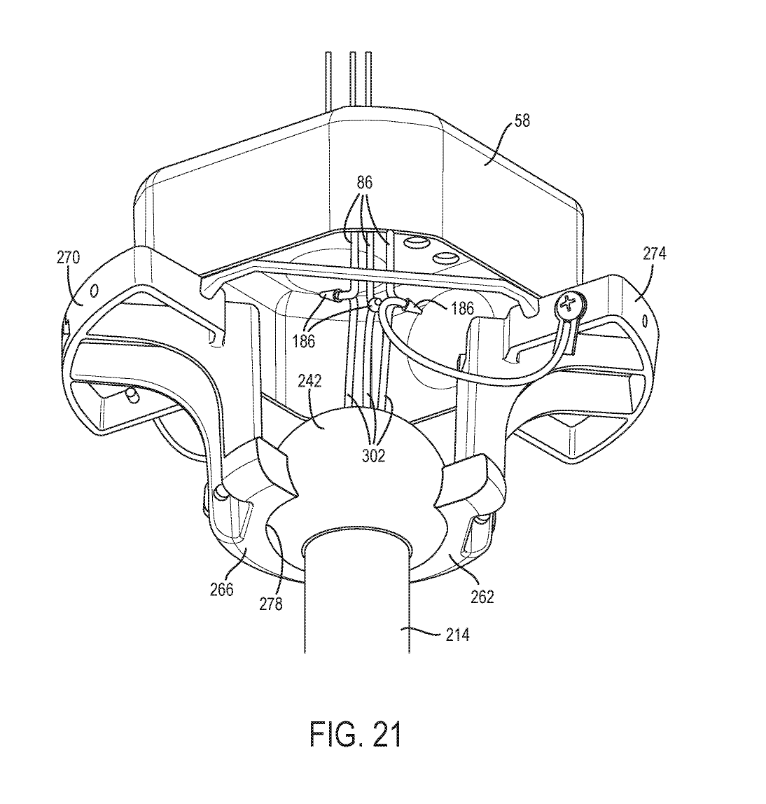

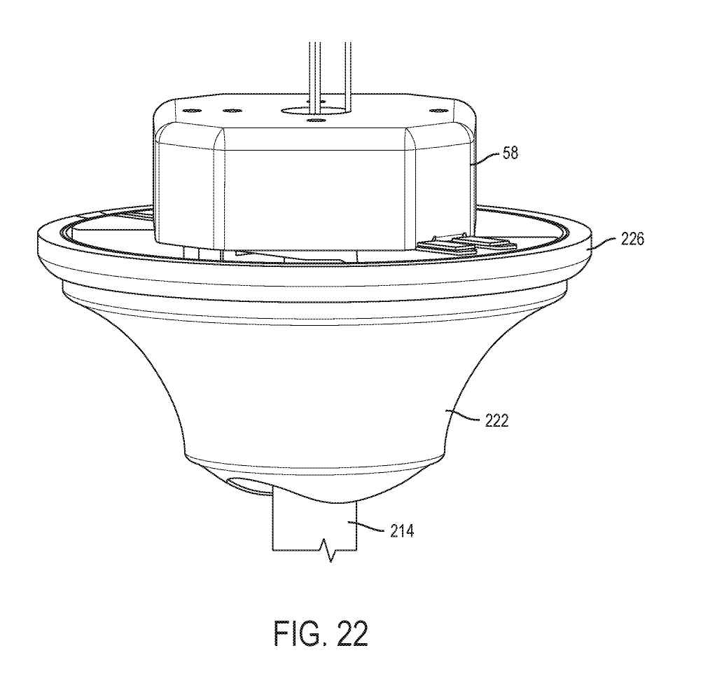

Before the downrod 214 can be coupled to the electrical box 58, the lower bezel 230 is slid along the downrod 214 until the adaptor bracket 250 is covered. The canopy 222 and screw cover 226 are also slid down the downrod 214 to contact the lower bezel 230 (FIG. 19). Next, the groove 246 on the hangar ball 242 is aligned with the tab 282 on the downrod mounting bracket 262. Then, the downrod 214 is tilted while the hangar ball 242 is positioned on the seat 278 of the downrod mounting bracket 262 (FIG. 20). In the illustrated embodiment, the downrod 214 is tilted about 45 degrees relative to the axis of rotation 42 before being positioned in the downrod mounting bracket 262. The lead wires 302 from the plug connector 74 are then connected to the existing home wires 86 using electrical wire nuts 186 (FIG. 21). The canopy 222 and screw cover 226 are slid to the first end 234 of the downrod 214 and fastened into place (FIG. 22). At this time, assembly of the installation system 218 is complete and the fan assembly 14 can be connected to the installation system 218 as described above.

The quick connect mechanism 18, 218 advantageously provides quick and easy installation of a fan assembly to a ceiling. The quick connect mechanism 18, 218 may be used to attach a fan assembly 14 to either an electrical box in the ceiling or an end of a downrod if it is desired to mount the fan further away from the ceiling.

Various features and advantages of the invention are set forth in the following claims.

What is claimed is:

1. A ceiling fan comprising:
a fan assembly including,
a motor housing having first and second mounting pins,
a motor positioned within the motor housing, the motor including a drive shaft that defines an axis of rotation,
a fan operable to be rotated by the motor, and
a first electrical terminal electrically coupled to the motor;
an installation system including,
a mounting bracket having a central portion, a first flange extending downwardly from the central portion, and a second flange extending downwardly from the central portion, the first flange including a first track and the second flange including a second track, and
an electrical connector, the electrical connector coupled to the mounting bracket, the electrical connector including a rotating terminal with a second electrical terminal; and
wherein the fan assembly is adapted to be coupled to the installation system by moving the first and second mounting pins within the first and second tracks in a first direction parallel to the axis of rotation to couple the first electrical terminal to the second electrical terminal and then rotating the fan assembly relative to the installation system about the axis of rotation to secure the fan assembly to the installation system.

2. The ceiling fan of claim 1, wherein the first and second tracks are L-shaped and the first and second tracks each include a first portion that is parallel to the axis of rotation and a second portion that is perpendicular to the axis of rotation.

3. The ceiling fan of claim 1, wherein the installation system further includes a latch mechanism operable to secure the fan assembly to the installation system.

4. The ceiling fan of claim 1, wherein a diameter of the first mounting pin is larger than a diameter of the second mounting pin.

5. The ceiling fan of claim 1, wherein the first electrical terminal is a male electrical terminal and the second electrical terminal is a female electrical terminal.

6. The ceiling fan of claim 1, wherein the mounting bracket remains fixed while the rotating terminal rotates with the fan assembly.

7. The ceiling fan of claim 6, wherein the rotating terminal rotates thirty degrees about the axis of rotation.

8. The ceiling fan of claim 1, wherein the installation system is coupled at a lower end of a downrod.

9. The ceiling fan of claim 1, wherein the installation system is configured to couple to the fan assembly at a first position adjacent a ceiling and is configured to couple to the fan assembly at a second position at a lower end of a downrod.

10. A ceiling fan comprising:
an installation system having a mounting bracket and an electrical connector coupled to the mounting bracket, the electrical connector including a rotating terminal with a first electrical terminal; and
a fan assembly coupled to the installation system, the fan assembly having a motor housing, a motor positioned within the motor housing and including a drive shaft that defines an axis of rotation, a fan operable to be rotated by the motor, and a second electrical terminal electrically coupled to the motor;
wherein the fan assembly is adapted to be coupled to the installation system by moving the fan assembly axially along the axis of rotation to couple the first electrical terminal to the second electrical terminal, then by rotating the fan assembly about the axis of rotation to secure the fan assembly to the installation system; and
wherein the installation assembly is configured to couple to the fan assembly at a first position adjacent a ceiling and is configured to couple to the fan assembly at a second position at a lower end of a downrod.

11. A ceiling fan comprising:
a fan assembly including,
a motor housing,
a motor positioned within the motor housing, the motor including a drive shaft that defines an axis of rotation,
a fan operable to be rotated by the motor, and
a first electrical terminal electrically coupled to the motor;
a downrod having a first end adjacent a ceiling and a second end opposite the first end; and
an installation system coupled to the second end of the downrod, the installation system including a mounting bracket and an electrical connector coupled to the mounting bracket, the electrical connector including a rotating terminal with a second electrical terminal that couples to the first electrical terminal to couple the fan assembly to the installation system.

12. The ceiling fan of claim 11, wherein the fan assembly is adapted to be coupled to the installation system by moving the fan assembly axially along the axis of rotation to couple the first electrical terminal to the second electrical terminal, then by rotating the fan assembly about the axis of rotation to secure the fan assembly to the installation system

13. The ceiling fan of claim 11, wherein the fan assembly further includes a canopy covering the second end of the downrod and a lower bezel that partially covers the installation system.

14. The ceiling fan of claim 11, wherein the downrod extends a distance from the ceiling.

15. The ceiling fan of claim 14, wherein the distance is within a range between 12 inches and 72 inches.

16. A ceiling fan comprising:
a fan assembly including,
a motor housing having first and second mounting pins,
a motor positioned within the motor housing, the motor including a drive shaft that defines an axis of rotation,
a fan operable to be rotated by the motor, and
a first electrical terminal electrically coupled to the motor; and
an installation system including,
a mounting bracket having a first track and a second track on a diametrically opposite side of the mounting bracket from the first track,
an electrical connector coupled to the mounting bracket, the electrical connector including a rotating terminal with a second electrical terminal configured to couple to the first electrical terminal to supply power to the motor, and
a latch mechanism positioned at one end of the first track, the latching mechanism moveable between a first closed position in which the first mounting pin is secured within the first track to couple the fan assembly to the installation system and a second open position in which the fan assembly is able to rotate relative to the installation system within the first track.

17. The ceiling fan of claim 16, wherein the latch mechanism includes a pivotable hook that is biased to the closed position.

18. The ceiling fan of claim 16, further comprising a release mechanism that is operable to move the latch mechanism to the open position.

19. The ceiling fan of claim 18, wherein the release mechanism includes a cable having a first end coupled to the latch mechanism and a second end opposite the first end with a release ring.

20. The ceiling fan of claim 16, wherein the fan assembly is adapted to be coupled to the installation system by moving the fan assembly axially along the axis of rotation to couple the first electrical terminal to the second electrical terminal, then by rotating the fan assembly about the axis of rotation to secure the fan assembly to the installation system.
